(19) United States
(12) Patent Application Publication
(10) Pub. No.: US 2026/0267760 A1
(43) Pub. Date: Sep. 10, 2026

(54) MODALITY CONVERSION OF PHYSICAL SYSTEM DATA FOR CONTEXTUAL PROCESSING

(71) Applicant: TDK SensEI Pte. Ltd., Singapore (SG)

(72) Inventors: Sandeep PANDYA, San Jose, CA (US); Sundeep AHLUWALIA, San Jose, CA (US); Ross MCGOWAN, San Jose, CA (US)

(73) Assignee: TDK SensEI Pte. Ltd., Singapore (SG)

(21) Appl. No.: 19/553,990

(22) Filed: Mar. 2, 2026

Related U.S. Application Data
(60) Provisional application No. 63/766,740, filed on Mar. 4, 2025.

(51) Int. Cl. G06F 11/34; G06F 11/30

(52) U.S. Cl. CPC G06F 11/3409; G06F 11/3089

(57) ABSTRACT

An apparatus may include circuitry configured to receive data obtained by one or more sensors associated with a physical system, convert the data into one or more elements that differ in structure from the data, and provide, based on the one or more elements, a state of the physical system.

### CROSS-REFERENCE TO RELATED APPLICATION

This application claims the benefit of U.S. Provisional Application No. 63/766,740, filed Mar. 4, 2025, which is incorporated herein by reference in its entirety.

### BACKGROUND

Physical systems operate in accordance with mechanical, electrical, thermal, or other physical principles. Such physical systems may include one or more components that interact during operation and may generate measurable signals through associated sensors. Characteristics of system behavior may depend on various factors, such as component configurations, operating parameters, environmental conditions, usage history, and system interactions.

### SUMMARY

In some aspects, the techniques described herein relate to an apparatus, including: circuitry configured to: receive data obtained by one or more sensors associated with a physical system; convert the data into one or more elements that differ in structure from the data; and provide, based on the one or more elements, a state of the physical system.

In some aspects, the techniques described herein relate to a non-transitory computer-readable medium storing a set of instructions, the set of instructions including one or more instructions that, when executed by one or more processors of an apparatus, cause the apparatus to: receive data obtained by one or more sensors associated with a physical system; convert the data into one or more elements that differ in structure from the data; and provide, based on the one or more elements, a state of the physical system.

In some aspects, the techniques described herein relate to a method, including: receiving data obtained by one or more sensors associated with a physical system; converting the data into one or more elements that differ in structure from the data; and providing, based on the one or more elements, a state of the physical system.

### BRIEF DESCRIPTION OF THE DRAWINGS

FIGS. 1A-1E are diagrams of an example associated with modality conversion of physical system data for contextual processing.

FIG. 2 is a diagram of example components of a device associated with modality conversion of physical system data for contextual processing.

FIG. 3 is a diagram of an example environment in which systems and/or methods described herein may be implemented.

FIG. 4 is a flowchart of an example process associated with modality conversion of physical system data for contextual processing.

### DETAILED DESCRIPTION

The following detailed description of example implementations refers to the accompanying drawings. The same reference numbers in different drawings may identify the same or similar elements.

Physical systems, such as industrial machines, motors, pumps, manufacturing equipment, and other apparatuses, are associated with data (e.g., obtained by sensors) during operation. Such data may include vibration measurements, thermal readings, current consumption signals, acoustic data, and other telemetry values. Characteristics of behavior of the system may be based on operational parameters, environmental conditions, component interactions, and historical usage patterns associated with the physical system.

The data obtained by the sensors associated with the physical systems is difficult to represent in a manner that preserves operational meaning while enabling contextual interpretation across variations. As system complexity increases and multiple sensing modalities are deployed, relationships among different telemetry sources and contextual factors become increasingly difficult to evaluate in an integrated manner.

Additionally, operational understanding of a physical system is based not only on sensor measurements but also on contextual and external information, such as environmental conditions, maintenance history, system configuration, and prior operating states. Integrating such heterogeneous information sources into a unified representation suitable for contextual reasoning presents challenges, such as when the data obtained by the sensors is continuous, high-frequency, and structurally distinct from symbolic or discrete representational formats.

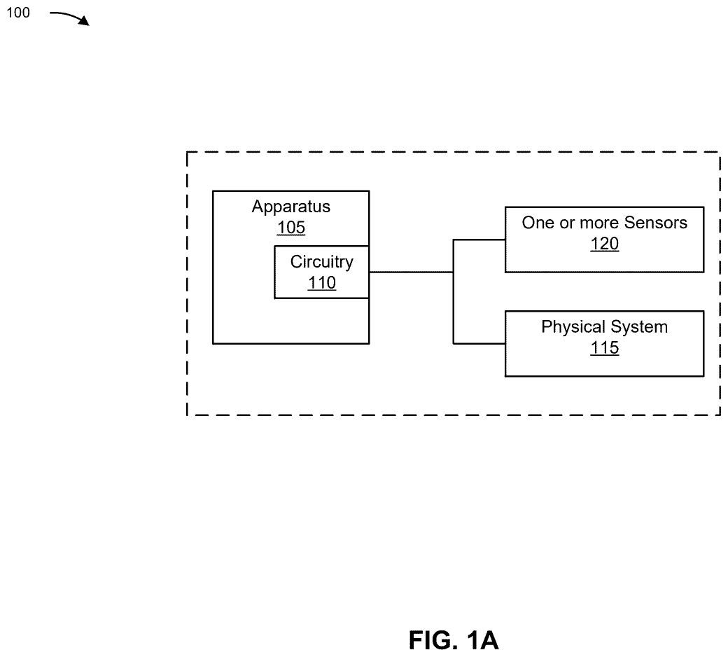

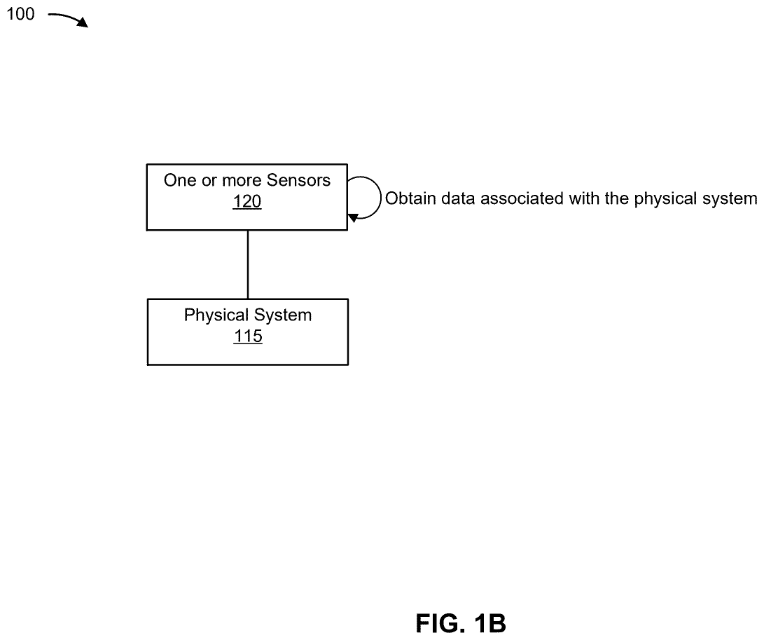

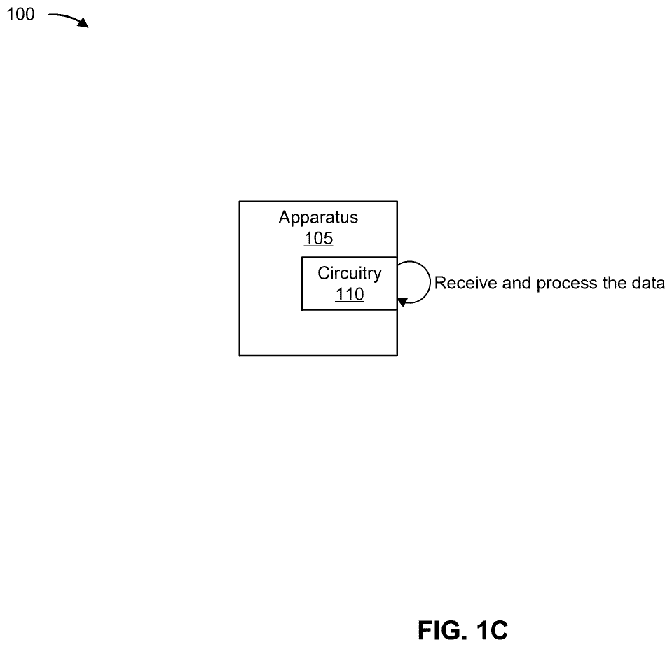

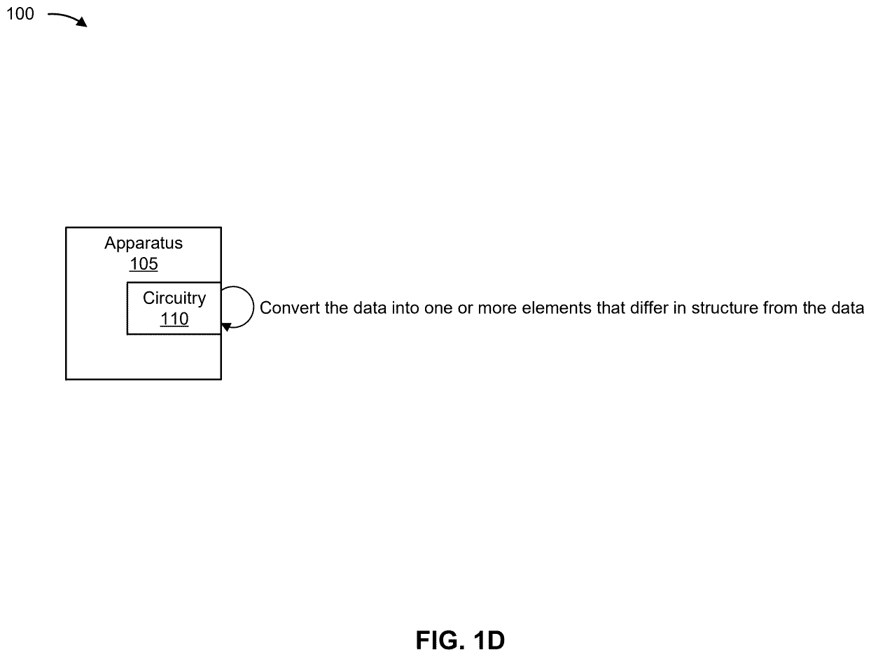

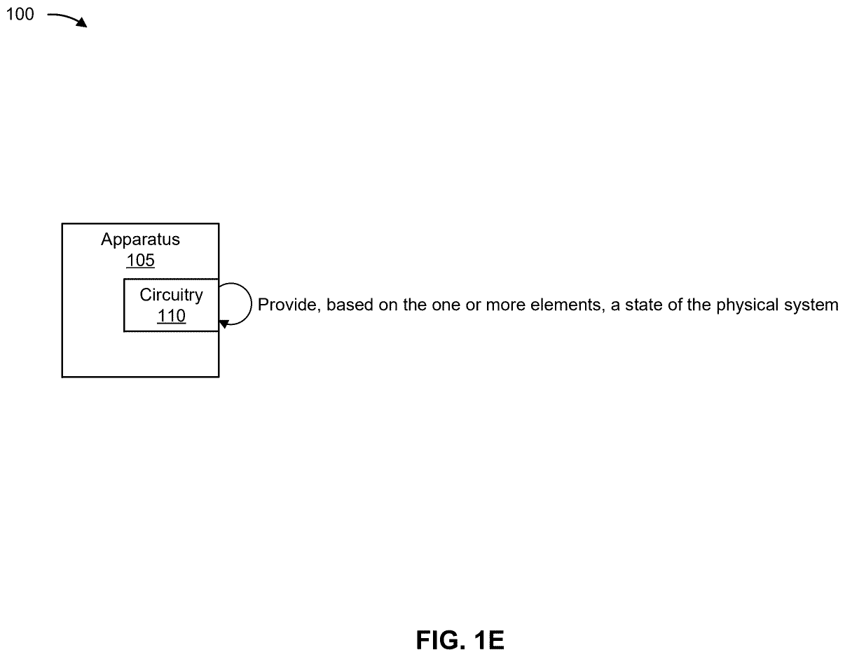

FIGS. 1A-1E are diagrams of an example associated with modality conversion of physical system data for contextual processing. As shown in FIG. 1A, the example 100 includes an apparatus 105 (shown as including circuitry 110), a physical system 115, and one or more sensors 120 (e.g., associated with the physical system 115). In some implementations, the circuitry 110 may be configured to process data obtained by the one or more sensors 120 and/or other data associated with the physical system 115, as described in more detail elsewhere herein.

In some implementations, the circuitry 110 may be configured to convert the data into one or more elements, where the one or more elements include representations that differ in structure from the data (e.g., differ in format, dimensionality, encoding, abstraction level, symbolic structure, and/or representation domain), among other examples. In some implementations, the one or more elements may be associated with a shared latent representation space that enables similarity-based comparison across heterogeneous data modalities.

In some implementations, the apparatus 105 may be located at or near the physical system 115 (e.g., as an edge device), remotely from the physical system 115 (e.g., within a cloud-based or distributed computing system), and/or partially distributed across multiple locations.

As shown in FIG. 1B, the one or more sensors 120 may be configured to obtain data associated with the physical system 115. For example, the one or more sensors 120 may obtain data representative of operation, condition, behavior, performance, configuration, and/or environment of the physical system 115. As an example, the data may include values (e.g., telemetry values), such as vibration values, temperature values, current measurements, voltage measurements, acoustic signals, magnetometer values, magnetic field measurements, electromagnetic measurements, vision sensor data, camera data, image data, video data, infrared imaging data, depth imaging data, pressure measurements, position measurements, displacement measurements, speed measurements, torque values, flow measurements, optical measurements, chemical measurements, and/or other measurable signals associated with the physical system 115, among other examples. In some implementations, the data may further include derived features, aggregated metrics, statistical indicators, event markers, and/or state indicators, among other examples.

In some implementations, the one or more elements may represent operational characteristics, degradation indicators, behavioral patterns, environmental influences, transitions between states, contextual relationships, and/or other characteristics abstracted from the data. In this way, the circuitry 110 may structurally transform raw measurement values and heterogeneous data into a representational modality suitable for contextual processing.

In some implementations, the data associated with the physical system 115 may include non-sensor data in addition to, or instead of, data generated by the one or more sensors 120. For example, the non-sensor data may include configuration information, maintenance records, usage history, operational logs, control parameters, environmental metadata, documentation, operator inputs, and/or other contextual information associated with the physical system 115, among other examples. In some implementations, the non-sensor data may originate from internal system controllers, programmable logic controllers (PLCs), supervisory control systems, enterprise resource planning systems, manufacturing execution systems, asset management systems, user interfaces, external databases, or other information systems associated with the physical system 115.

In some implementations, the physical system 115 may include one or more mechanical, electrical, electromechanical, thermal, hydraulic, pneumatic, optical, chemical, and/or hybrid systems and/or one or more components, subsystems, assemblies, and/or integrated platforms associated with such systems. For example, the physical system 115 may include industrial equipment, manufacturing machinery, motors, generators, pumps, compressors, turbines, engines, vehicles, aircraft systems, maritime systems, robotic systems, automated production lines, material handling systems, energy generation systems, energy storage systems, computing infrastructure (e.g., servers, cooling systems, and/or power distribution systems), transportation systems, building management systems, medical devices, consumer devices, structural monitoring systems, and/or other machinery and/or equipment (e.g., that operates according to physical principles), among other examples. In some implementations, the physical system 115 may include distributed components operating cooperatively within a facility, across multiple locations, and/or within an environment (e.g., a networked environment), among other examples. In some implementations, the physical system 115 may include cyber-physical systems in which physical components and digital control systems interact, such that data representative of both physical behavior and control behavior may be processed.

In some implementations, the data (e.g., obtained by the one or more sensors 120 and/or otherwise obtained and/or sourced) may be continuous, discrete, periodic, aperiodic, streaming, batched, structured, unstructured, and/or semi-structured, among other examples. As an example, the data may include time-varying measurements, multi-dimensional measurements, image data, video data, pixel arrays, feature maps, object detection outputs, segmentation outputs, sampled signals, aggregated measurements, derived features, event-based measurements, and/or state-based measurements, textual information, categorical information, metadata, and/or configuration information, among other examples. In some implementations, the data may be generated at different sampling rates, resolutions, or time scales, and may originate from heterogeneous modalities that differ in format, structure, encoding, dimensionality, and/or semantic meaning. For example, such structural transformations may include converting a continuous numeric time-series signal into a discrete token sequence, converting tabular telemetry into embedding vectors in a latent representation space, converting text-based maintenance logs into semantic embeddings, and/or converting multi-dimensional sensor arrays into symbolic state identifiers, among other examples.

In some implementations, the data includes values (e.g., numeric, categorical, textual, event-based, and/or multi-dimensional values, among other examples), and the circuitry 110 may be configured to convert at least a portion of the values into identifiers (e.g., tokens, symbols, indices, vectors, labels, and/or indicators, among other examples) corresponding to the one or more elements. In some implementations, converting the values into identifiers may include applying an encoding, discretization, quantization, embedding, clustering, feature extraction, and/or mapping procedure to transform the values into structured representations that differ in format and/or abstraction level from the original data. For example, numeric telemetry values may be discretized into bins and/or state ranges, textual values may be encoded into semantic vectors, and/or multi-dimensional sensor outputs may be transformed into feature vectors and/or state labels representing characteristics (e.g., operational characteristics) of the physical system 115, among other examples.

As shown in FIG. 1C, the circuitry 110 may be configured to receive and process the data (e.g., obtained by the one or more sensors 120 and/or otherwise obtained and/or sourced). For example, the one or more sensors 120 may be configured to transmit the data via wired or wireless communication links, and the circuitry 110 may be configured to receive the data directly or indirectly via one or more intermediate apparatuses, edge apparatuses, gateways, network components, cloud-based systems, storage systems, databases, application programming interfaces (APIs), message queues, data streams, files, logs, user interfaces, and/or external information systems, among other examples. In some implementations, receipt of the data may occur in real time, near real time, asynchronously, synchronously, periodically, on-demand, and/or in response to one or more triggering events associated with the physical system 115 and may include aggregation of data from multiple heterogeneous sources prior to conversion.

In some implementations, the circuitry 110 may be configured to perform one or more operations prior to converting the data into one or more elements. For example, preprocessing may include filtering, normalization, synchronization, alignment, scaling, feature extraction, denoising, compression, data fusion, aggregation, validation, formatting, time-windowing, interpolation, data quality assessment, and/or other transformations applied to the data prior to structural conversion, among other examples. In some implementations, preprocessing may enable harmonization of heterogeneous data sources such that the data is prepared for structural transformation into the one or more elements.

As shown in FIG. 1D, the circuitry 110 may be configured to convert the data into one or more elements that differ in structure from the data. For example, the circuitry 110 may be configured to transform measurement values, contextual information, derived information, and/or heterogeneous data sources into a representational form that is structurally distinct from the original data format. In some implementations, the one or more elements represent one or more characteristics of the physical system 115 abstracted from the data.

In some implementations, the one or more elements include token identifiers representing at least one state of the physical system 115.

In some implementations, conversion includes altering dimensionality, encoding scheme, data type, representation domain, symbolic structure, abstraction level, or combinations thereof relative to the original data.

In some implementations, the conversion may include transforming numeric, continuous, categorical, textual, event-based, and/or multi-dimensional data into one or more elements, such as discrete elements, symbolic identifiers, encoded representations, learned representations, quantized representations, embeddings, state indicators, and/or other representations configured to represent one or more characteristics associated with the physical system 115. In some implementations, the circuitry 110 may be configured to arrange the one or more elements as a sequence, such as an ordered sequence representing variation of the physical system 115 over time.

In some implementations, the ordered sequence may be structured for contextual processing by a model configured to analyze and/or model relationships among the one or more elements, such as dependencies (e.g., temporal dependencies), transitions (e.g., state transitions), relationships (e.g., cross-modal relationships), and/or associations (e.g., learned associations), among other examples.

In some implementations, the model may include supervised algorithms implemented using one or more supervised models (e.g., sequence models, transformer-based models, probabilistic models, and/or neural network models trained using labeled data), unsupervised algorithms implemented using one or more unsupervised models (e.g., clustering models, representation learning models, autoencoders, and/or latent variable models), and/or semi-supervised algorithms implemented using one or more semi-supervised models (e.g., hybrid symbolic-neural models and/or models trained using partially labeled data), among other examples. As an example, the model may be configured to process the ordered sequence of elements derived from sensor data associated with the physical system to learn relationships, patterns, and/or transitions (e.g., state transitions) to improve detection, prediction, and/or characterization of operational states of the physical system (e.g., relative to processing of the raw sensor data).

In some implementations, the circuitry 110 may be configured to train the model using the one or more elements and/or associated states of the physical system 115. Training may be performed using ordered sequences of the one or more elements and/or associated states to enable the model to learn contextual relationships, patterns, and/or state transitions associated with operation of the physical system 115. In some implementations, the model may implement supervised learning in which labeled states are associated with sequences of the one or more elements, unsupervised learning to identify clusters and/or latent structures within the one or more elements, self-supervised learning to learn contextual relationships among the one or more elements, and/or hybrid learning approaches, among other examples.

In this way, the circuitry 110 may convert heterogeneous data associated with the physical system 115 into a representational modality that abstracts operational meaning from raw measurement magnitudes, structural formats, sampling characteristics, and/or source-specific encoding schemes, among other examples.

In some implementations, the one or more elements may be configured to enable contextual processing across sequences, relationships, transitions, and/or dependencies among the elements.

As shown in FIG. 1E, the circuitry 110 may be configured to provide, based on the one or more elements, a state of the physical system 115. In some implementations, the state may include an operational state, degradation state, fault state, predicted future state, reliability state, health state, performance state, configuration state, or other condition indicative of behavior of the physical system 115. In some implementations, the circuitry 110 may incorporate contextual information associated with the physical system 115 into the one or more elements prior to providing the state.

In some implementations, the circuitry 110 may generate, based on the state, a signal associated with operation of the physical system 115. In some implementations, operation of the physical system 115 may be modified based on the signal. The state may be determined based on contextual relationships among multiple elements, temporal sequences of elements, cross-modal interactions, and/or learned associations derived from prior data.

In some implementations, the circuitry 110 may be configured to obtain a set of observations associated with one or more physical systems 115. For example, an observation may correspond to data generated during a period of operation of the physical system 115 and may include telemetry values generated by the one or more sensors 120 and/or contextual information associated with the physical system 115. As an example, the observations may be obtained from historical operation, real-time operation, simulated operation, stored records, and/or external data sources, among other examples.

In some implementations, the circuitry 110 may be configured to process the observations to identify data corresponding to one or more variables associated with the physical system 115. For example, the circuitry 110 may be configured to derive features, variables, and/or attributes from telemetry values, configuration information, environmental conditions, maintenance history, usage history, documentation, operator inputs, and/or other contextual data sources associated with the physical system 115.

In some implementations, the circuitry 110 may be configured to convert the data included in the observations into one or more elements that differ in structure from the original data. For example, the circuitry 110 may be configured to transform telemetry values and/or contextual information into discrete elements, symbolic identifiers, token identifiers, quantized representations, embeddings, learned representations, clustered representations, and/or other representational elements that abstract one or more characteristics of the physical system 115. As an example, the one or more elements may include token identifiers representing at least one state of the physical system 115 and/or representing transitions between states, among other examples.

In some implementations, the circuitry 110 may be configured to arrange the one or more elements (e.g., as an ordered sequence) such that the one or more elements represent variation of the physical system 115, such as over time and/or across one or more conditions (e.g., one or more operating conditions), among other examples. For example, the arrangement may represent progression of operating modes, transitions between states, degradation patterns, anomalous behavior, recovery patterns, and/or contextual events associated with the physical system 115, among other examples.

In some implementations, the circuitry 110 may be configured to structure the one or more elements as an ordered sequence for contextual processing (e.g., as described in more detail elsewhere herein). As an example, the ordered sequence may be provided to a model configured to analyze, model, and/or infer relationships among the one or more elements, such as dependencies (e.g., temporal dependencies), transitions (e.g., state transitions), relationships (e.g., cross-modal relationships), and/or associations (e.g., learned associations), among other examples. In some implementations, the model may implement supervised, unsupervised, semi-supervised, and/or self-supervised learning using one or more contextual computational models to operate on the ordered sequence and generate representations (e.g. structured representations) indicative of such relationships.

In some implementations, the circuitry 110 may be configured to implement retrieval-augmented processing in connection with contextual evaluation of the one or more elements. For example, the circuitry 110 may be configured to retrieve stored representations, prior sequences of the one or more elements, historical observations, documentation, maintenance records, domain knowledge, and/or other contextual information from one or more data stores and/or incorporate the retrieved information into contextual processing of the ordered sequence. Accordingly, in some implementations, retrieval-augmented generation techniques may be used such that retrieved contextual information (e.g., retrieved contextual conditions, constraints, and/or supplements) may be used to evaluate the one or more elements, among other examples.

In some implementations, the circuitry 110 may be configured to maintain and update a memory structure storing previously processed sequences of the one or more elements, associated states, outcomes, and/or feedback, among other examples. For example, the circuitry 110 may be configured to retrieve similar prior sequences based on similarity in the representational modality and/or incorporate the retrieved sequences into contextual processing (e.g., to enable memory-augmented reasoning, case-based reasoning, and/or knowledge-grounded inference), among other examples.

In some implementations, the circuitry 110 may be configured to receive a new observation associated with the physical system 115 and to convert the data of the new observation into one or more elements that differ in structure from the original data. For example, the circuitry 110 may be configured to apply the same or similar conversion procedures used during training to generate an ordered sequence of elements corresponding to the new observation.

In some implementations, the circuitry 110 may be configured to provide the one or more elements and/or the ordered sequence to the model for contextual processing. For example, the circuitry 110 may be configured to condition model evaluation on retrieved contextual information, prior cases, domain knowledge, and/or relevant documentation obtained via retrieval operations, among other examples.

In some implementations, the circuitry 110 may be configured to determine, based on contextual processing of the one or more elements, a state of the physical system 115. For example, the state may include an operational state, degradation state, fault state, predicted future state, reliability state, health state, configuration state, and/or another condition indicative of behavior of the physical system 115, among other examples.

In some implementations, the circuitry 110 may be configured to generate output based on the determined state. For example, the circuitry 110 may generate a recommendation, an alert, a confidence score, a probability distribution associated with one or more states, a similarity measure relative to prior observations, a cluster assignment, and/or another representation indicative of characteristics of the physical system 115, among other examples.

In some implementations, the circuitry 110 may be configured to generate, based on the determined state, a signal associated with operation of the physical system 115. For example, the signal may include a control signal, a maintenance scheduling signal, a configuration adjustment signal, a notification signal, and/or another signal configured to modify operation of the physical system 115, among other examples. In some implementations, operation of the physical system 115 may be modified automatically and/or semi-automatically in response to the signal.

In this way, the circuitry 110 may be configured to convert data obtained by one or more sensors, and/or otherwise obtained, associated with the physical system 115 into a representational modality distinct from the original data, structure the representational modality for contextual processing (e.g., using retrieval-augmented and/or memory-augmented processing techniques), determine a state of the physical system 115 based on contextual relationships among one or more elements, and modify operation of the physical system 115 based on the determined state, among other examples. Some other implementations may differ in ordering, representation type, model architecture, retrieval mechanism, and/or control actions performed, among other examples. Additionally, or alternatively, the representational modality enables comparison and contextual reasoning across different physical systems, operating environments, and/or sensing configurations by abstracting source-specific structural differences into a unified representation space.

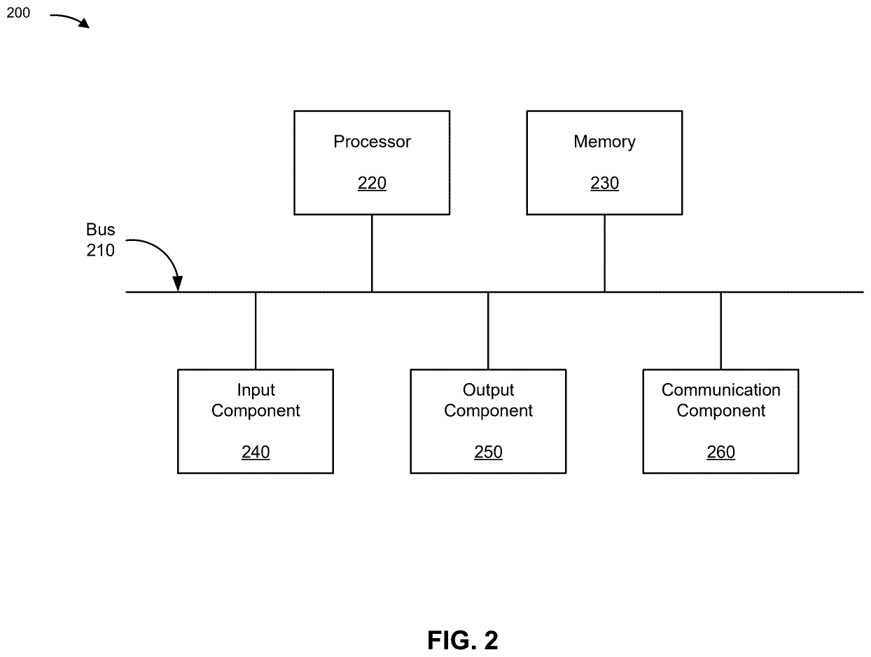

FIG. 2 is a diagram of example components of a device 200 associated with modality conversion of physical system data for contextual processing. In some implementations, the device 200 may correspond to circuitry (e.g., circuitry 110 of the apparatus 105) configured to receive data generated by one or more sensors, and/or otherwise obtained, associated with a physical system, convert the data into one or more elements that differ in structure from the data, and provide, based on the one or more elements, a state of the physical system.

In some implementations, the device 200 may be implemented as an edge apparatus proximate to the physical system, a server, a cloud-based computing apparatus, a controller, an embedded computing platform, and/or another type of computing apparatus configured to perform one or more operations described herein. As shown in FIG. 2, the device 200 may include a bus 210, a processor 220, a memory 230, an input component 240, an output component 250, and/or a communication component 260.

The bus 210 may include one or more components that enable wired and/or wireless communication among the components of the device 200. The bus 210 may couple together two or more components of FIG. 2, such as via operative coupling, communicative coupling, electronic coupling, and/or electric coupling. For example, the bus 210 may include an electrical connection (e.g., a wire, a trace, and/or a lead) and/or a wireless bus. The processor 220 may include a central processing unit, a graphics processing unit, a microprocessor, a controller, a microcontroller, a digital signal processor, a field-programmable gate array, an application-specific integrated circuit, and/or another type of processing component.

The processor 220 may be implemented in hardware, firmware, or a combination of hardware and software. In some implementations, the processor 220 may include one or more processors capable of being programmed to perform one or more operations or processes described elsewhere herein, including conversion of sensor data into representational elements, arranging elements into ordered sequences, performing contextual processing of the elements, and/or providing a state of a physical system based on the elements.

The memory 230 may include volatile and/or nonvolatile memory. For example, the memory 230 may include random access memory (RAM), read only memory (ROM), a hard disk drive, and/or another type of memory (e.g., a flash memory, a magnetic memory, and/or an optical memory). The memory 230 may include internal memory and/or removable memory. The memory 230 may be a non-transitory computer-readable medium. The memory 230 may store information, one or more instructions, and/or software related to operation of the device 200.

In some implementations, the memory 230 may store instructions that, when executed by one or more processors, cause the device 200 to receive data obtained by one or more sensors, and/or otherwise obtained, associated with a physical system, transform telemetry values included in the data into one or more elements that differ in structure from the data, arrange the elements (e.g., as an ordered sequence) such that the elements represent variation of the physical system, incorporate contextual information into the elements, and/or provide a state of the physical system based on the elements, among other examples.

The input component 240 may enable the device 200 to receive input, such as sensed input and/or system input. For example, the input component 240 may include an interface to one or more sensors, a data acquisition interface, an industrial communication interface, a controller interface, a network interface, and/or another component capable of receiving data associated with a physical system. In some implementations, the input component 240 may receive telemetry values generated by one or more sensors and/or may receive contextual information associated with the physical system, such as environmental information, configuration information, historical information, and/or maintenance information, among other examples.

The output component 250 may enable the device 200 to provide output. For example, the output component 250 may provide an indication of a state of the physical system, may provide an alert, may provide a recommendation, and/or may provide a signal configured to modify operation of the physical system. The communication component 260 may enable the device 200 to communicate with other devices via a wired connection and/or a wireless connection. For example, the communication component 260 may include a receiver, a transmitter, a transceiver, a modem, a network interface card, and/or an antenna, and may enable communication with sensors, controllers, actuators, edge devices, cloud systems, supervisory systems, or other computing devices.

The device 200 may be configured to perform one or more operations or processes described herein. For example, a non-transitory computer-readable medium (e.g., memory 230) may be configured to store a set of instructions for execution by the processor 220. The processor 220 may be configured to execute the set of instructions to perform one or more operations or processes described herein, including converting data generated by one or more sensors into one or more representational elements that differ in structure from the data and providing, based on the elements, a state of the physical system.

In some implementations, execution of the set of instructions, by one or more processors 220, may cause the one or more processors 220 and/or the device 200 to perform one or more operations or processes described herein. In some implementations, hardwired circuitry may be used instead of or in combination with the instructions to perform one or more operations or processes described herein. Thus, implementations described herein are not limited to any specific combination of hardware circuitry and software.

The number and arrangement of components shown in FIG. 2 are provided as an example. In practice, the device 200 may include additional components, fewer components, different components, or differently arranged components than those shown in FIG. 2. Additionally, or alternatively, a set of components of the device 200 may perform one or more functions described as being performed by another set of components of the device 200.

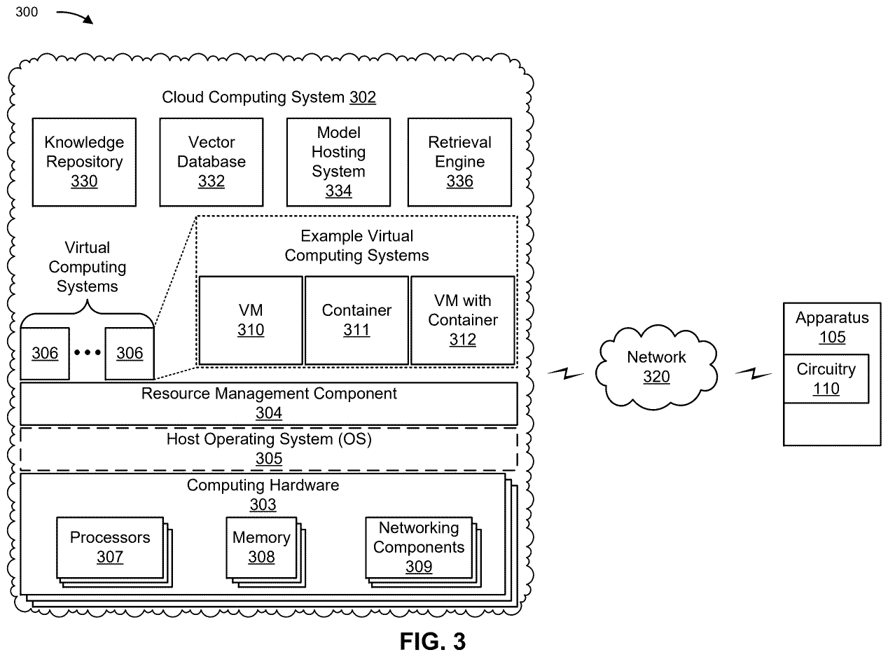

FIG. 3 is a diagram of an example environment 300 in which systems and/or methods described herein may be implemented. As shown in FIG. 3, the environment 300 may include a cloud computing system 302. In some implementations, the cloud computing system 302 may include computing hardware 303, a resource management component 304, a host operating system 305, one or more virtual computing systems 306 (e.g., including a VM 310, a container 311, and a VM with container 312), a knowledge repository 330, a vector database 332, a model hosting system 334, and a retrieval engine 336. In some implementations, an apparatus 105 (e.g., including circuitry 110) may execute within, communicate with, and/or be partially implemented by the cloud computing system 302. In some implementations, the apparatus 105 may communicate with the cloud computing system 302 via a network 320.

In some implementations, the computing hardware 303 may include one or more processors, one or more memories, one or more storage devices, and/or one or more networking components. The resource management component 304 may virtualize the computing hardware 303 to provide one or more virtual computing systems 306, such as virtual machines, containers, or hybrid environments, among other examples. In some implementations, the model hosting system 334 may execute within one or more of the virtual computing systems 306.

In some implementations, the model hosting system 334 may be configured to host and/or execute one or more contextual processing models configured to evaluate relationships among one or more elements generated by the circuitry 110. For example, the model hosting system 334 may host a sequence model, a transformer-based model, a probabilistic model, a neural network model, a hybrid model, and/or another contextual computational model configured to process ordered sequences of elements representing variation of a physical system over time, among other examples.

In some implementations, the knowledge repository 330 may store contextual information associated with one or more physical systems. For example, the knowledge repository 330 may include documentation, configuration data, maintenance records, operational logs, historical performance data, environmental information, engineering specifications, prior state determinations, annotations, and/or other structured or unstructured information associated with one or more physical systems, among other examples.

In some implementations, the vector database 332 may store encoded representations (e.g., embeddings) associated with contextual information, prior observations, historical states, and/or other data associated with one or more physical systems. For example, the circuitry 110 and/or the model hosting system 334 may generate embeddings corresponding to textual, numerical, categorical, and/or multi-modal data, and the embeddings may be stored in the vector database 332 to enable similarity-based retrieval, contextual augmentation, and/or comparative analysis, among other examples.

In some implementations, the retrieval engine 336 may be configured to retrieve contextual information from the knowledge repository 330 and/or the vector database 332 based on one or more elements generated by the circuitry 110. For example, the circuitry 110 may provide one or more elements (e.g., token identifiers, symbolic representations, embeddings, or other representational units) to the retrieval engine 336, and the retrieval engine 336 may retrieve relevant contextual information based on similarity measures, semantic relationships, state associations, threshold criteria, or other retrieval techniques. In some implementations, retrieved contextual information may be incorporated into contextual processing performed by the model hosting system 334.

In some implementations, one or more elements generated by the circuitry 110 may be transmitted via the network 320 to the cloud computing system 302. The retrieval engine 336 may be configured to use the elements to query the vector database 332 for contextually relevant information stored in the knowledge repository 330. As an example, retrieved information may be provided to the model hosting system 334 to augment model inference. The model hosting system 334 may be configured to determine a state of the physical system and transmit the determined state, recommendation, or control signal back to the apparatus 105 via the network 320.

In some implementations, the circuitry 110 may be configured to provide one or more elements and/or ordered sequences of elements to the model hosting system 334 for contextual processing. The model hosting system 334 may evaluate relationships among the one or more elements, optionally augmented by contextual information retrieved by the retrieval engine 336, to determine a state of a physical system. In some implementations, this configuration may correspond to retrieval-augmented contextual processing in which external knowledge is incorporated into model evaluation.

In some implementations, the apparatus 105 may operate in coordination with the cloud computing system 302 such that conversion of data into one or more elements occurs at an edge device proximate to a physical system, while contextual processing, retrieval operations, model execution, and/or state determination occur within the cloud computing system 302. In other implementations, conversion, retrieval, contextual processing, and state determination may be performed entirely within the cloud computing system 302, entirely at the edge, or in a distributed manner across multiple systems connected via the network 320.

In some implementations, the knowledge repository 330 may be configured to store information associated with one or more physical systems, such as historical telemetry data, contextual information, maintenance records, configuration data, documentation, operational logs, fault reports, simulation outputs, model outputs, and/or other information relevant to evaluation of the physical system 115. As an example, the knowledge repository 330 may be configured to store structured data, semi-structured data, and/or unstructured data, and/or may be configured to support indexing, metadata tagging, versioning, and/or access control mechanisms, among other examples. In some implementations, the knowledge repository 330 may include one or more databases, file systems, document stores, object stores, data lakes, and/or other storage architectures, among other examples.

In some implementations, the vector database 332 may be configured to store vector representations corresponding to information stored in the knowledge repository 330 and/or corresponding to elements generated from physical system data. As an example, the vector representations may include embedding vectors generated from telemetry-derived elements, contextual data, documentation, and/or other information associated with the physical system 115. For example, the vector database 332 may be configured to support similarity search, nearest-neighbor search, approximate nearest-neighbor search, clustering operations, and/or other vector-based retrieval techniques, among other examples. In some implementations, the vector representations may reside in a shared latent representation space that enables comparison across heterogeneous data modalities.

In some implementations, the model hosting system 334 may be configured to host and/or execute one or more computational models configured for contextual processing of the one or more elements generated from physical system data. As an example, the computational models may include transformer-based models, sequence models, neural network models, probabilistic models, hybrid models, multimodal models, large language models, and/or other contextual processing architectures. For example, the model hosting system 334 may support training, fine-tuning, inference, version management, scaling, and/or distributed execution of models. In some implementations, the model hosting system 334 may receive augmented input from the retrieval engine 336 to perform retrieval-augmented inference.

In some implementations, the retrieval engine 336 may be configured to perform embedding-based similarity search within the vector database 332 to identify information relevant to the one or more elements generated from physical system data. As an example, retrieved information may be provided to the model hosting system 334 as contextual augmentation input (e.g., retrieval-augmented generation), such as to enable evaluation of the one or more elements in view of historical records, documentation, maintenance data, and/or prior observations, among other examples.

In some implementations, the one or more elements generated by the apparatus 105 (e.g., via circuitry 110) may be transmitted via the network 320 to the cloud computing system 302. The elements may be used by the retrieval engine 336 to query the vector database 332 for information stored in the knowledge repository 330 that is contextually relevant to the elements. Retrieved information may be provided to the model hosting system 334 as contextual augmentation input, enabling augmented model inference based on both the elements derived from the physical system and retrieved knowledge. The model hosting system 334 may determine a state of the physical system based on the augmented input and may transmit the determined state, recommendation, or control signal back to the apparatus 105 via the network 320.

In this way, the environment 300 may enable integration of structural conversion of heterogeneous physical system data, storage of contextual information, retrieval of relevant contextual knowledge, contextual model processing of ordered sequences of elements, and determination of states of physical systems, among other examples.

In some implementations, the knowledge repository 330, the vector database 332, the model hosting system 334, and the retrieval engine 336 may be implemented within one or more virtual computing systems 306 (e.g., the VM 310, the container 311, and/or the VM with container 312) of the cloud computing system 302. In some other implementations, one or more of these components may be implemented as managed services external to the cloud computing system 302 and accessible via the network 320. Accordingly, FIG. 3 illustrates logical relationships among components, and physical deployment may vary.

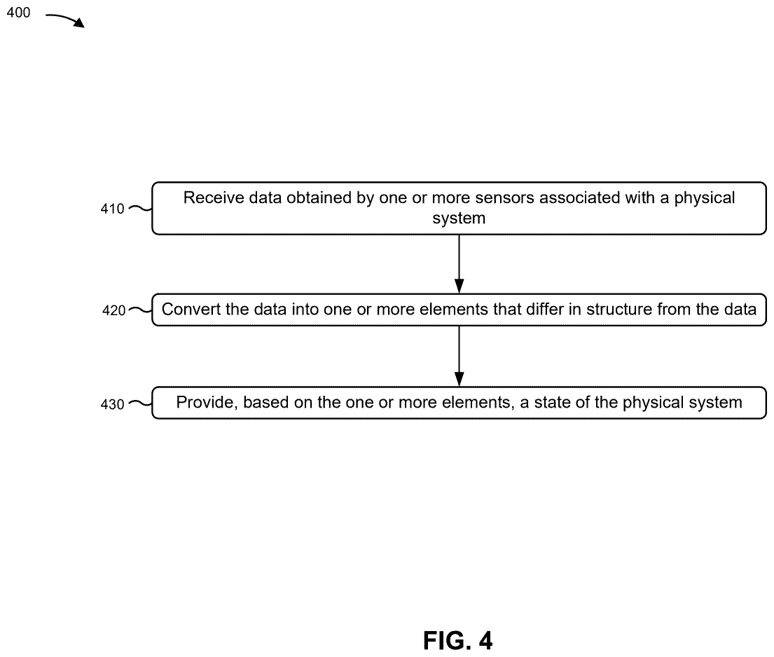

FIG. 4 is a flowchart of an example process 400 associated with modality conversion of physical system data for contextual processing. In some implementations, one or more process blocks of FIG. 4 may be performed by circuitry (e.g., the circuitry 110 of the apparatus 105). In some implementations, one or more process blocks of FIG. 4 may be performed by another device or a group of devices separate from or including the device, such as a physical system 115, one or more components associated with the physical system 115, and/or one or more sensors (e.g., the one or more sensors 120), among other examples. Additionally, or alternatively, one or more process blocks of FIG. 4 may be performed by one or more components of the device 200, such as the processor 220, the memory 230, the input component 240, the output component 250, and/or the communication component 260, and/or by the cloud computing system 302, the computing hardware 303, the resource management component 304, the host operating system 305, the one or more virtual computing systems 306, the knowledge repository 330, the vector database 332, the model hosting system 334, and/or the retrieval engine 336, among other examples.

As shown in FIG. 4, the process 400 may include receiving data obtained by one or more sensors associated with a physical system (block 410). For example, the circuitry may be configured to receive data obtained by one or more sensors associated with a physical system, as described in more detail elsewhere herein.

As further shown in FIG. 4, the process 400 may include converting the data into one or more elements that differ in structure from the data (block 420). For example, the circuitry may be configured to convert the data into one or more elements that differ in structure from the data, as described in more detail elsewhere herein.

As further shown in FIG. 4, the process 400 may include providing, based on the one or more elements, a state of the physical system (block 430). For example, the circuitry may be configured to provide, based on the one or more elements, a state of the physical system, as described in more detail elsewhere herein.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

In some implementations, the techniques described herein provide an improvement to computer functionality and/or to the technological field of contextual processing of physical system data. Typical approaches to evaluating physical system telemetry rely on direct processing of raw measurement signals or on modality-specific pipelines that independently analyze vibration data, thermal data, electrical signals, acoustic data, or other sensing modalities. Such approaches often require multiple specialized models, high storage overhead, and substantial computational resources to preserve fine-grained signal characteristics while attempting to perform contextual reasoning.

In contrast, the circuitry 110 may be configured to structurally transform sensor data (e.g., heterogeneous and/or multi-dimensional sensor data and/or other contextual data) into a representational modality that differs in structure from the original data. For example, by converting signals (e.g., continuous, high-frequency, and/or modality-specific measurement signals) into representations (e.g., tokens, embeddings, symbolic identifiers, and/or state representations), the circuitry 110 may be configured to reduce dimensionality, normalize formats (e.g., heterogeneous formats), and enable comparison within a representation space (e.g., similarity-based comparison within a shared latent representation space), among other examples. This structural transformation enhances computational efficiency, reduces storage requirements associated with raw telemetry retention, and streamlines contextual evaluation by enabling a model (e.g., a contextual model) to operate across multiple sensing modalities.

In one embodiment, the circuitry 110 may convert sensor data, in the form of electronic signals, into representations such as tokens. These tokens may be treated as small chunks of electronic data similar to that of words, parts of words or characters for natural language processing. In some embodiments, these tokens may be used to process, train and generate additional tokens. For example, vibration data (e.g., time series data) from first machine (e.g., motor, pump) within first factory can be tokenized into foundational model for second machine within the first factory, for third machine within the first factory, and so forth. The machines can be of particular type or model but need not be the same. In some embodiments, the foundational model can be used across particular type or model of machines in a second factory, a third factory, and so forth. While vibration data is discussed above, in some instances, thermal, video and audio data, among others, may also be tokenized, individually or collectively, to represent different states of the machine. In one embodiment, the tokenized data can be strung into a string of information to build the foundational model. In another embodiment, the foundational model can be further refined, fine-tuned or optimized, for deployment across various type or model of machines or across different facilities and locations.

In some implementations, arranging the one or more elements as an ordered sequence enables contextual models (e.g., sequence models, transformer-based models, probabilistic models, neural network models, and/or hybrid models) to evaluate dependencies (e.g., temporal dependencies), relationships (e.g., cross-modal relationships), and/or transitions (e.g., state transitions) using structured inputs (e.g., rather than raw sensor streams). This enhances model operation by enabling long-range contextual reasoning across time and across heterogeneous modalities while mitigating noise sensitivity and modality-specific preprocessing burdens. Accordingly, some implementations described herein improve the functioning of models (e.g., contextual computational models) by providing structured inputs that preserve operational meaning while reducing structural complexity relative to raw measurement processing.

In some implementations, retrieval-augmented and/or memory-augmented processing further improves technological performance by enabling contextual evaluation, such as by using previously stored representations, historical observations, and domain knowledge without requiring direct reprocessing of full historical raw telemetry. This may reduce storage overhead, reduce redundant computation, and improve system scalability when deployed across multiple physical systems and environments. Such improvements are directed to improving how the computer system stores, retrieves, and processes representations associated with physical systems.

In some implementations, the techniques described herein improve the technological field of physical system monitoring and control by enabling more accurate, earlier, and more context-aware determinations (e.g., relative to evaluation of raw sensor measurements alone). For example, structural conversion into a representational modality enables detection of degradation patterns, compound failure modes, and contextual anomalies that may not be identifiable through independent thresholding or isolated signal analysis. In some implementations, generating a signal (e.g., a control signal) based on the determination and modifying operation of the physical system may reduce downtime, improve reliability, reduce unnecessary maintenance, and improve operational efficiency.

Accordingly, some implementations described herein provide a technological solution to a technological problem associated with representing, integrating, and contextually evaluating heterogeneous physical system data. The improvements described herein relate to the manner in which computer systems structurally transform, store, retrieve, and contextually process data associated with physical systems, which improves computer functionality and/or the technological field of physical system monitoring and control.

As used herein, satisfying a threshold may, depending on the context, refer to a value being greater than the threshold, greater than or equal to the threshold, less than the threshold, less than or equal to the threshold, equal to the threshold, not equal to the threshold, or the like.

As used herein, a phrase referring to “at least one of” a list of items refers to any combination and permutation of those items, including single members (e.g., an individual item in the list of items). As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list of items). As an example, “a, b, and/or c” is intended to cover a, b, c, a-b, a-c, b-c, and a-b-c.

No element, act, or instruction described herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used herein. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. An apparatus, comprising:
circuitry configured to:
receive data obtained by one or more sensors associated with a physical system;
convert the data into one or more elements that differ in structure from the data; and
provide, based on the one or more elements, a state of the physical system.

2. The apparatus of claim 1, wherein the data includes telemetry values associated with the physical system, and the circuitry is further configured to transform at least a portion of the telemetry values into the one or more elements.

3. The apparatus of claim 2, wherein the one or more elements include token identifiers representing at least one state of the physical system.

4. The apparatus of claim 1, wherein the one or more elements represent one or more characteristics of the physical system abstracted from the data.

5. The apparatus of claim 1, wherein the circuitry is further configured to arrange the one or more elements as an ordered sequence representing variation of the physical system.

6. The apparatus of claim 5, wherein the ordered sequence is structured for contextual processing.

7. The apparatus of claim 1, wherein the one or more sensors include at least one of a vision sensor or a camera configured to generate at least one of image data or video data associated with the physical system.

8. A non-transitory computer-readable medium storing a set of instructions, the set of instructions comprising one or more instructions that, when executed by one or more processors of an apparatus, cause the apparatus to:
receive data obtained by one or more sensors associated with a physical system;
convert the data into one or more elements that differ in structure from the data; and
provide, based on the one or more elements, a state of the physical system.

9. The non-transitory computer-readable medium of claim 8, wherein the one or more instructions, when executed by the one or more processors, further cause the apparatus to:
transform at least a portion of telemetry values included in the data into the one or more elements.

10. The non-transitory computer-readable medium of claim 8, wherein the one or more instructions, when executed by the one or more processors, further cause the apparatus to:
receive at least one of image data or video data from at least one of a vision sensor or a camera associated with the physical system and convert the at least one of the image data or the video data into the one or more elements.

11. The non-transitory computer-readable medium of claim 8, wherein the one or more instructions, when executed by the one or more processors, further cause the apparatus to:
arrange the one or more elements as an ordered sequence representing variation of the physical system.

12. The non-transitory computer-readable medium of claim 8, wherein the data further includes contextual information associated with the physical system, and the one or more instructions, when executed by the one or more processors, further cause the apparatus to:
convert the contextual information into one or more additional elements together with the data obtained by the one or more sensors.

13. The non-transitory computer-readable medium of claim 8, wherein the state includes at least one of an operational state, a degradation state, or a fault state.

14. The non-transitory computer-readable medium of claim 8, wherein the one or more instructions, when executed by the one or more processors, further cause the apparatus to:
structure the one or more elements for contextual processing by a model configured to evaluate relationships among the one or more elements.

15. A method, comprising:
receiving data obtained by one or more sensors associated with a physical system;
converting the data into one or more elements that differ in structure from the data; and
providing, based on the one or more elements, a state of the physical system.

16. The method of claim 15, wherein receiving the data includes receiving at least one of image data or video data from at least one of a vision sensor or a camera associated with the physical system.

17. The method of claim 15, further comprising:
arranging the one or more elements as an ordered sequence representing variation of the physical system over time.

18. The method of claim 15, wherein the one or more elements are structured for contextual sequence processing.

19. The method of claim 15, further comprising:
incorporating contextual information associated with the physical system into the one or more elements prior to providing the state.

20. The method of claim 15, further comprising:
generating, based on the state, a signal associated with operation of the physical system; and
modifying operation of the physical system based on the signal.
